(19) United States
(12) Patent Application Publication
(10) Pub. No.: US 2008/0313278 A1
(43) Pub. Date: Dec. 18, 2008

(54) METHOD AND APPARATUS FOR SHARING VIDEOS

(75) Inventor: Alon HOCHBERG, Tel Aviv (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: LINQEE LTD, Tel-Aviv (IL)

(21) Appl. No.: 11/953,104

(22) Filed: Dec. 10, 2007

Related U.S. Application Data
(60) Provisional application No. 60/944,508, filed on Jun. 17, 2007.

(51) Int. Cl. G06F 15/16

(52) U.S. Cl. 709/204

(57) ABSTRACT

A method and apparatus for sharing a multimedia stream between an initiator and one or more viewers. The initiator's platform transcodes the multimedia into a stream, based on parameters, indications and commands received from all viewers including the initiator. Thus, the multimedia stream is presented to all viewers without having to upload the clip to a storage server, thus accounting for immediate synchronized display, enabling all viewers to control the stream by stopping, seeking a position or the like. In streaming the multimedia, the quality of service available at each viewer computing platform is considered, so that the multimedia remains synchronized also if one or more viewers have a slower connection.

### TECHNICAL FIELD

The present invention relates to the field of digital streams general, and to an apparatus and method for sharing streams between multiple parties, in particular.

### BACKGROUND

The improved availability of digital imaging and in particular digital video capturing, as well as the improvement in processing capabilities of computers and increased bandwidth encourage users to share their videos with other parties, for personal purposes as well as professional ones. In order to share a video with another party, most current technologies require the installation of a particular application, or the creation or personalized web page in order to share videos.

Another limitation imposed by current technologies relates to a requirement from the video initiator to upload the stream in its entirety to an external third party server. Then, other parties interested in viewing the video should download the stream to their computers. This requirement implies a long preparation time, which is at least the upload time of the entire video, which implies delays in viewing. Further, these technologies do not enable the initiator of the video stream and the other viewers to view the stream synchronously or immediately. Simultaneous and synchronous viewing is desired in order for the viewers to share and discuss the video in real time, for example: “Notice the person approaching the car from the left”. However, if such synchronization is problematic due to differences in equipment, line quality or other factors differing between the parties, it is generally impossible to enhance the video and adapt it to the available conditions. Thus, if a one party is connected through a low bandwidth connection, this party will receive a lower quality and slower video transmission, and will not be able to share the video synchronously with other parties.

Further, even if the view is synchronized for all viewers, it is not possible for all viewers to equally manipulate the way they view the stream, i.e. start, stop, pause, fast forward or backward or the like. It is often required that any viewer, including the initiator as well as other parties can stop or otherwise manipulate the video according at their choice, make comments to other viewers, draw their attention or otherwise interact with them.

Yet another drawback of the requirement to upload the video to a third party server is the exposure of the view streams to uninvited viewers, which endangers the security and privacy of the video owner, of people appearing in the video, or of other people or entities. Once the video is stored on a third party server, it is available to the public, which is not desired for private videos, whether personal or business oriented.

There is thus a need in the art for a method and apparatus that enables a video initiator to share a video stream with other parties. All parties should be able to view the stream immediately, instantly, simultaneously and synchronously, regardless of differences in equipment and connection quality differences. It is a further requirement that all viewers will be able to manipulate the video presentation by stopping, pausing, seeking a position within the video or other actions, that will affect the video presented to all other parties. The method and apparatus should support the security and privacy of every entity associated with the video, by not exposing the video to uninvited viewers.

### SUMMARY

The disclosure relates to a method and apparatus for sharing a multimedia clip, such as a video between an initiator and multiple viewers. The streaming of the multimedia takes into account the limitations, conditions, parameters, and resources of the equipment used by the initiator and viewers, and enables the initiator or any viewer to control the presentation of the multimedia shown to all other participants. Since the multimedia is not stored on an external server, the upload time is spared, and all participants receive the multimedia instantly and synchronously.

An aspect of the disclosure discloses in a computerized network, a method for sharing a multimedia clip between an initiator and one or more viewers, the initiator using an initiator computing platform and each viewer using a viewer computing platform, the computing platforms connected to the network via connections, the method comprising: streaming the multimedia clip into streamed multimedia, the streaming performed in accordance with one or more considerations; downloading the streamed multimedia to the computing platforms of the initiator and the viewers; presenting the streamed multimedia to the initiator and to the viewers; sending the considerations from the initiator or from any viewer to the initiator; and updating the streaming of the multimedia clip according to the considerations. Within the method, the multimedia clip is optionally a video clip or a sound clip or comprises one or more images. Within the method, the consideration optionally relates to the initiator computing platform, or the viewers computing platforms, or to the connections used by the initiator computing platform or a viewer computing platform, or to a control command issued by the initiator or by a viewer, or to a cue point monitoring indication sent by the initiator computing platform or a viewer computing platform, or to a quality of service parameter issued by the initiator computing platform or any viewer computing platform. The quality of service parameter optionally relates to a network resource or platform capabilities of the initiator computing platform or any viewer computing platform. Within the method, the streamed multimedia is optionally presented synchronously or instantly to the initiator and to the viewers. The method can further comprise a step of uploading the streamed multimedia to a streaming server. The method can further comprise a step of sending an invitation from the initiator to the viewers. The invitation is optionally sent as an e-mail or s an instant message. The method optionally comprises the steps of encrypting and decrypting the invitation. The invitation optionally comprises one or more of the following: a Universal Resource Locator (URL); a Universal Resource Identifier (URI); a Session Initiation Protocol (SIP) command; or an Internet Protocol (IP) address. The method optionally comprises the steps of compressing and decompressing, the multimedia stream or the considerations, or the steps of encrypting and decrypting the multimedia stream or the considerations.

Another aspect of the disclosure relates to a computerized apparatus for sharing a multimedia clip between an initiator and an one or more viewers, the initiator using an initiator computing platform and the viewers using viewers computing platform, the computing platforms connected to the network via connections, the viewer computing platform executing a viewer component, and the initiator computing platform executing: a viewer component for displaying the multimedia and transmitting an at least one consideration to the streamer component; one or more analyzer components for analyzing indications received from the viewer computing platform or from the viewer component; and a streamer component for streaming the multimedia clip and generating a multimedia stream according to the considerations received from the viewer computing platform or from the initiator computing platform. Within the apparatus, the multimedia clip is optionally a video clip or an audio clip or an image. Within the computerized apparatus, the viewer component optionally comprises: a player component for displaying the multimedia stream and transmitting the considerations to the streamer component executed by the initiator computing platform; and one or more indicator components for issuing to the initiator computing platform the considerations related to the viewer computing platform or the viewer or the initiator computing platform or the initiator. Within the apparatus, the analyzer component optionally comprises one or more items selected from the group consisting of: a quality of service analyzer for integrating quality of service indications from the viewer computing platforms and from the initiator computing platform; a network analyzer for integrating network resources indications received from the viewer computing platform or from the initiator computing platform; and a control analyzer for integrating control commands received from the at least one viewer or from the initiator. Within the computerized apparatus, the indicator component optionally comprises one or more items selected from the group consisting of: a network analyzer for obtaining and transmitting to the initiator computing platform one or more indications related to network characteristics of the viewer computing platform and connection or the initiator computing platform and connection; a quality of service protocol implementation component for obtaining and transmitting to the initiator computing platform one or more quality parameters related to the multimedia stream; and a control protocol implementation component for receiving one or more control commands from the viewer or from the initiator and transferring the control commands to the initiator computing platform. The computerized apparatus can further comprise one or more streaming servers for receiving the multimedia stream from the initiator computing platform and sending the multimedia stream to the viewer computing platforms and to the initiator computing platform. The streamer component optionally comprises one or more items selected from the group consisting of: a quality of service protocol implementation component, a network implementation component; and a control protocol implementation component.

Yet another aspect of the disclosure relates to a computer readable storage medium containing a set of instructions for a general purpose computer, the set of instructions comprising: a streaming component for streaming a multimedia clip into streamed multimedia, the multimedia clip to be shared between an initiator using an initiator computing platform and an at least one viewer using an at least one viewer computing platform, the streaming performed in accordance with one or more considerations; a downloading component for downloading the streamed multimedia to the initiator computing platform and to the viewer computing platforms; a presentation component for presenting the streamed multimedia to the viewers and to the initiator; and a component for sending the considerations from the initiator or a viewer to the initiator.

BRIEF DESCRIPTION OF THE DRAWINGS

Non-limiting embodiments of the invention will be described with reference to the following description of exemplary embodiments, in conjunction with the figures. The figures are generally not shown to scale and any sizes are only meant to be exemplary and not necessarily limiting. In the figures, identical structures, elements or parts that appear in more than one figure are preferably labeled with a same or similar number in all the figures in which they appear, in which:

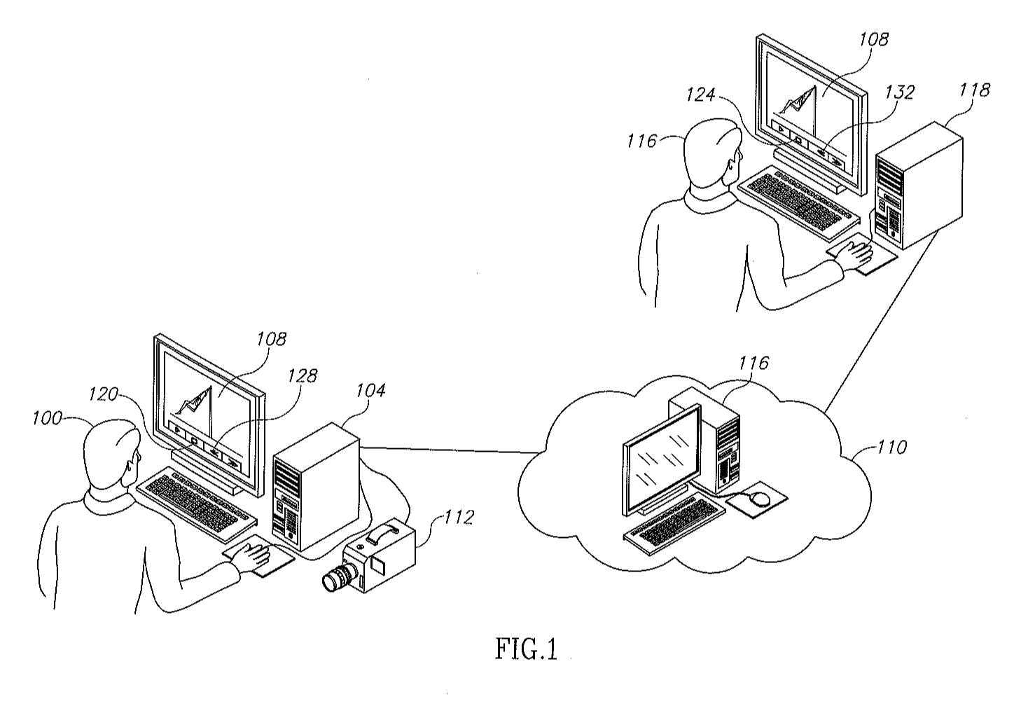

FIG. 1 is a schematic illustration of a typical usage of the disclosed method and apparatus;

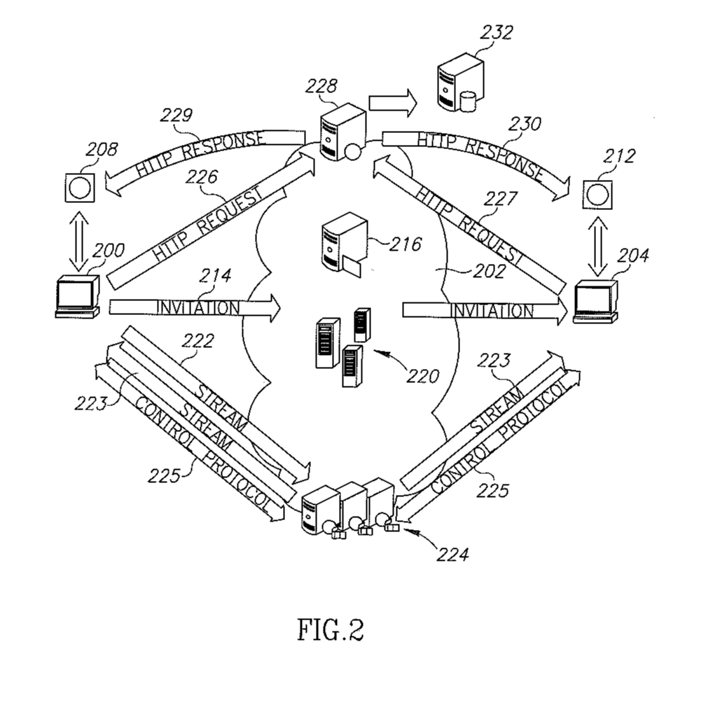

FIG. 2 is a schematic block diagram of preferred embodiments of the disclosed apparatus;

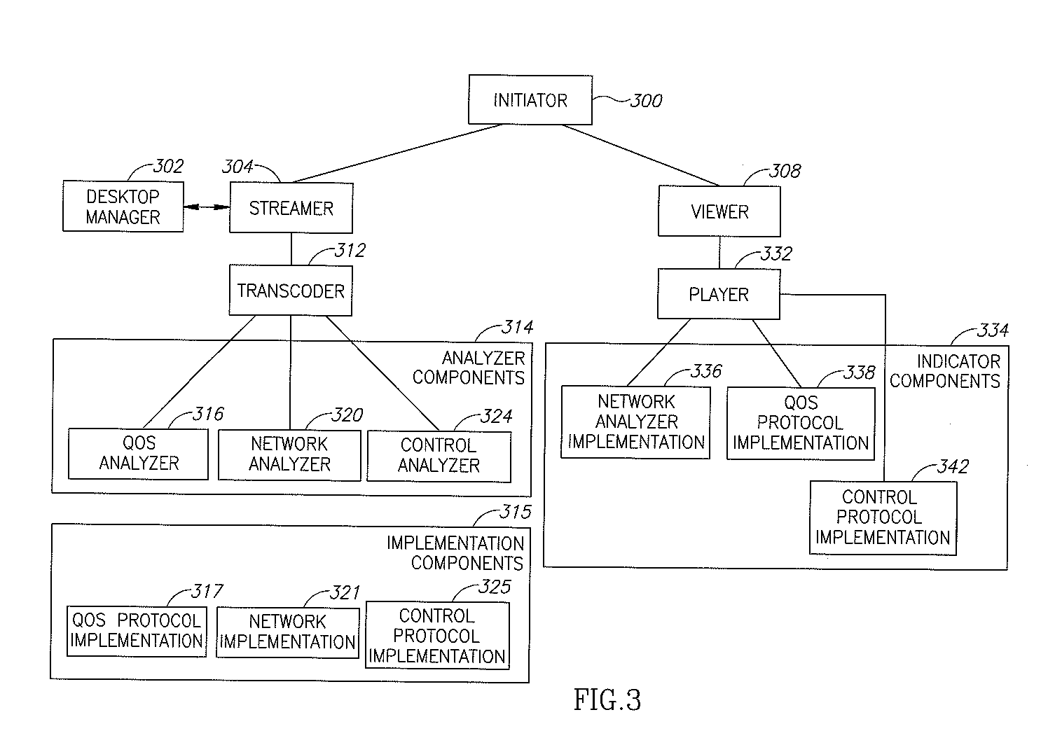

FIG. 3 is a schematic block diagram of the components in a preferred embodiment of an apparatus according to the disclosure;

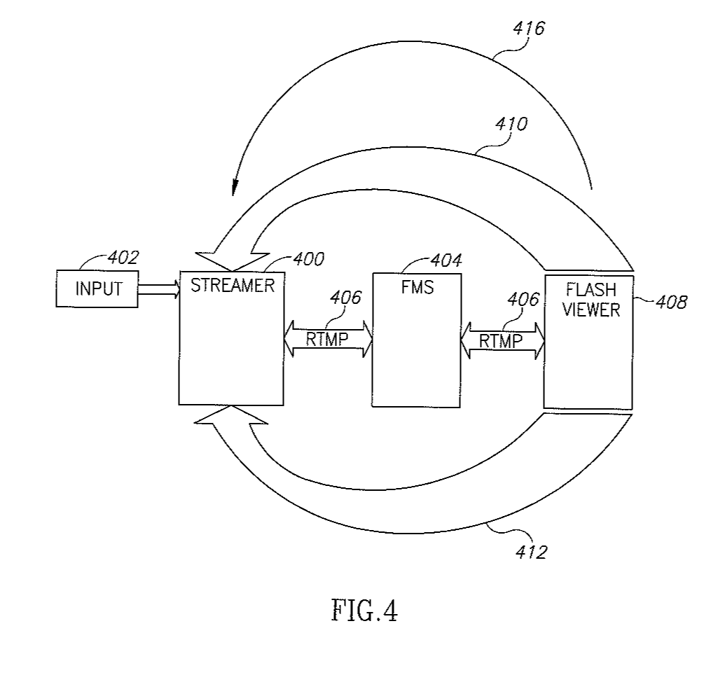

FIG. 4 is a schematic block diagram showing the messages and parameters transferred to and from the components of the disclosed apparatus; and

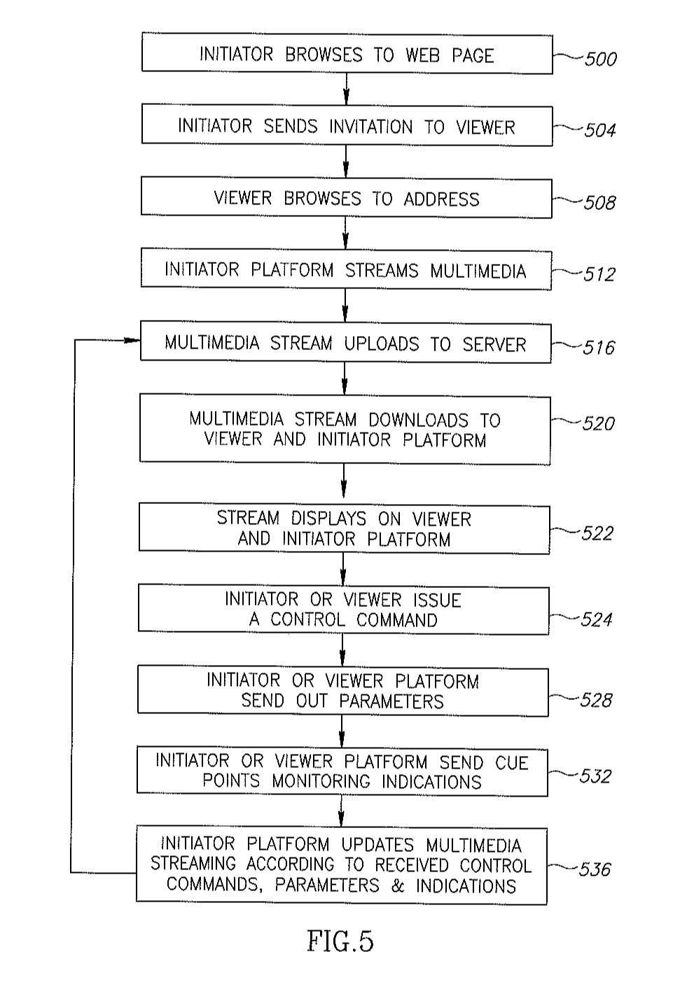

FIG. 5 is a schematic flowchart of a preferred embodiment of the disclosed method.

### DETAILED DESCRIPTION

A method and apparatus for sharing a multimedia clip, such as video capture, between an initiator and one or more viewers. The apparatus comprises a computerized platform used each of the other viewers. The initiator starts a viewing or presentation session by entering a web page and issuing an invitation to one or more viewers by e-mail, instant messaging or any other communication channel. Upon receiving the invitation, the invitees open the same web page. A streaming component within the initiator's system then starts transmitting the video stream according to parameters related to the stream. The video is optionally transmitted to a media streaming server, which can be external or located on the initiator's platform. The media streaming server than transmits the video to all viewers, including the initiator. Thus, the initiator views the video just as all other viewers and not via a different mechanism. Each of the computerized platforms, including the initiator's platform then issues control commands, parameters and indications to the initiator's platform. The control commands include commands issued by any of the viewers, such as stop, seek and the like. The indications include parameters related to the hardware of the platforms, the viewing rate, quality of service, network status, or other parameters. The streaming component within the initiator's platforms then combines the control commands and feedback indications and updates the streamed video to comply with the considerations of the viewers, the viewers' computing platform and connections and with their control commands, so that the same stream is sent to all viewers including the initiator at the same time. Thus, the initiator's system streams and sends the video stream, but beyond these activities the initiator is equal to all other viewers, and receives the steamed video as do all other parties. The video ream is at no stage stored on a third party storage device, thus providing for immediate presentation and protecting the privacy of people or entities associated with the video. Further, intruders can not access a video stored on an external server, and manipulate it change its contents, insert a virus or a Trojan horse or otherwise harm its contents.

Referring now to FIG. 1, showing a schematic illustration of a typical usage of the disclosed method and apparatus. In a computerized network a user 100 is a video initiator, using a computing platform 104. User 100 is using a browser installed and running on computing platform 104 to view web page 108. Via web page 108 user 100 is sharing a video steam. The clip to be shared is preferably stored on a hard disk of the initiator's computer, a connected video camera 112, a Network Attached Storage (NAS), or the like. The clip is preferably stored as a file, but any other storage option can be used. The clip is not limited in format, length or any other parameter, and can represent audio, video, text, images, data or the like. The clip is streamed by a streaming component installed on computing platform 104 according to multiple parameters, transferred via a communication channel 110 such as the internet, intranet or any other communication network to streaming server 116 which dispatches suing the same or other communication network it back to video initiator 100 as well as to further viewers such as viewer 116 using computing platform 118. All users such as video initiator 100 and viewer 116 watch the video by browsing to web page 108. Any user, such as video initiator 100 and viewer 116 can hit any button such as STOP buttons 120 or 124, fast forward buttons 128 or 132 or the like. The choices of each viewer will affect the way all other viewers view the video, so that all viewers see the video simultaneously and synchronously. Further, the hardware equipment and connection quality of each computing platform is fed back into the computing platform 104 and affects the streaming of the video, so that the video is suited for the conditions of all viewers and synchronization is maintained.

Referring now to FIG. 2, showing schematic block diagram of preferred embodiments of the disclosed apparatus. Each of initiator platform 200 and exemplary viewer platform 204 is a computing platform, such as a desktop computer, a laptop computer, mainframe or any other computing platform provisioned with a memory, CPU and communication ports. Initiator platform 200 is also provisioned with or has access to a storage device storing the original video to be shared. The storage can be a hard disk of platform 200 or external storage, such as an external disk or a video camera storing the video. It will be appreciated that the disclosure is not limited to a single viewer platform, and that multiple viewers can vide the video together with the initiator and the viewer using viewer platform 204. It will be further appreciated that viewer platform 204 can also be used as an initiator platform and share videos with a viewer using platform 200 or any other viewers.

Initiator platform 200 and viewer platform 204 execute interconnected sets of computer instructions, preferably arranged as software components such as executables, scripts, web pages, libraries, modules or the like. The components are detailed in association with FIG. 3 below.

Initiator platform 200 and viewer platform 204 are connected via communication channel 202, which is preferably the Internet, Intranet, Local Area Network (LAN), Wide Area Network (WAN) or the like. Communication channel 202 also connects platforms 200 and 204 to additional components detailed below.

Initiator platform 200 displays web page 208, through which the initiator sends an invitation 214 to the viewer using viewer platform 204. The invitation can take any format, such as an e-mail message sent via mail server 216, an instant message transferred via instant messaging server 220, a telephone call or the like. The Invitation optionally comprises a link to web page 208. Once the viewer receives and accepts the invitation, he or she also browses to web page 208.

The video stream is then streamed by initiator platform 200 and sent via streaming server 224 to viewer platform 204, and also back to initiator platform 200 and displayed by each of them on web page 208. Streaming server 224 relays the stream received from initiator platform 200 to all viewing platforms. In order to provide required processing capacity, fault resilience and to be able to meet geographical requirements, streaming server 224 may be implemented as one or more interconnected media servers. A preferred implementation of streaming server 224 uses Flash Media Server (FMS) by Adobe Systems Inc. (http://www.adobe.com/macromedia/proom/pr/2005/flashmediaserver2_ships.html). FMS is adjusted to work with a Flash Player runtime component to create media driven, multi-user RIAs (Rich Internet Applications). FMS provides infrastructure for media streaming and for the application level communication between all participants. Streaming server 224 is functional in serving as a media gateway and in transferring control protocol messages 225 and 226. The control messages can alternatively be passed in other ways not necessarily via streaming server 224, for example by web server 228. It will be appreciated by a person skilled in the art that the FMS implementation is exemplary only and streaming server 224 can alternatively be implemented using streaming or networking technology, such as Microsoft SilverLight platform made by Microsoft Inc. (www.microsoft.com) or others.

Control commands 225 and 226 refer to two main types: quality of service indications related to the equipment of the viewers upon which the rate and quality of the streamed video is determined, as well as control commands related to the viewer's requests, such as stop, pause, seek or the like.

It will be further appreciated that the video can be streamed to participants using peer-to-peer technology, thus avoiding the usage of streaming server 224. When peer-to-peer technology is used, the stream is sent by initiator platform 200 to all other viewers such as viewer 204, as well as to itself. However, even if the stream is uploaded to a streaming server from which it is downloaded to all viewers, the streaming server is not a storage server. The stream is not stored on the external server, and thus can not be accesses by uninvited viewers. The streaming server serves merely as a gateway for dispatching the stream to all viewers. The streaming server constitutes a part of the initiator's landscape and is not external to the initiator.

Web page 208 is a web page that displays the video and provides control capabilities for the viewers. Web page 208 is contained and executed by web server 228. Web server 228 is functional in receiving Hypertext Transfer Protocol (HTTP) requests 226, 227 from initiator platform 200 and viewer platform 204 and generating responses 229, 230 related to displaying web page 208. The apparatus optionally comprises database 232 which stores management data of the system, statistics, user information and the like. It will be appreciated that any of web server 228, mail server 216, instant messaging server 220 and streaming server 224 can be located on one computing platform, and any combination thereof can further be co-located on initiator platform 200.

Referring now to FIG. 3, showing a block diagram of the main components executed by initiator platform 200 and viewer platform 204 of FIG. 2. Platforms 200 and 204 execute computer instructions and are preferably interconnected software components arranged in executables, libraries, scripts or other components. Initiator components system 300 comprises a desktop component 302 and a streamer component 304 which are unique to the initiator's platform, and a viewer component 308 which is essentially identical to the viewer component executed by the platform of any other viewer. Thus, the initiator's platform and any viewer's platform execute essentially the same viewer component, but the initiator's platform also executes streamer component 304 and desktop manager 302. Desktop component 302 is also implemented as a web application or as an installable computer program that handles the administrative part of the initiator's session, including security, connection to devices, user interface for issuing invitations, or the like.

Viewer component 308, the same as the viewer components executed on computing platforms of viewers other than the initiator. Since it is desirable that viewers do not have to install any hardware or software components in order to view the videos, then viewer component 308 is implemented as part of the web page to which the initiator as well as the viewers browse in order to share the video. Viewer 308 comprises player 332 which displays the actual video receives on the web page. Player 332 optionally uses any proprietary or third party player, such as a Flash player platform produced by adobe (www.adobe.com). Viewer 308 further comprises one or more indicator components 334 for obtaining data, control commands or parameters, and transferring them to the initiator. Indicator components 334 comprise one or more of network analyzer 336, QoS protocol implementation 338 and control protocol implementation 342. Network analyzer 336 is functional in obtaining and transmitting to the initiator's platform indications related to the network characteristics, such as bandwidth, failure information or the like. QoS protocol implementation 338 is useful in obtaining and transmitting to the initiator's platform parameters related to the quality of the displayed video, including but not limited to the frame rate, the bandwidth request and response, a client QoS alert, a connection alert, or the like. The QoS preferably relates to indications embedded within the video stream. For example, when using FMS, cue points are produced by streamer 304 and embedded in the video stream every second of encoded stream, and server 224 of FIG. 2 uses the cue points to generate the stream according to the correct time line. In another preferred embodiment, the video stream can comprise a predetermined indication every 10 seconds, e.g. if the video rate is 24 frames per second, then every 240^{th} frame comprises this indication, and the viewers check the indication validity relatively to previous indications rather than relatively to the real timeline, in order to be able to work with constant delay situations.

Control protocol implementation 342 is useful in receiving from the viewer and transferring control commands, including but not limited to stop; pause; seek to position; fast forward; fast backward; and change content, i.e., select another media file instead of the original one and continuing the same session with the new media content. Viewer component 308 transfers from each viewer platform, including the initiator's platform, the all data from network analyzer 336, QoS protocol implementation component 338 and control protocol implementation component 342 to streamer component 304 executed by initiator 300.

Streamer component 304 is unique to the initiator and is preferably not installed on a viewer platform, unless the viewer also wishes to share videos with other parties. Streamer component 304 comprises one or more analyzer components 314 for integrating commands or parameters received from the viewers. Analyzer components 314 optionally include QoS analyzer 316 for integrating the QoS indications from all viewers, network analyzer 320 for integrating the network indications from all viewers, and control analyzer 324 for integrating control commands received from all viewers. The streamer further comprises implementation components 315, including Quality of Service protocol implementation 317, network implementation 321 and control protocol implementation 325 for communicating with network analyzer implementation 336, Quality of Service protocol implementation component 338 and control protocol implementation component 342 detailed below, embedded within each viewer, including the initiator.

Streamer 304 further comprises transcoder 312 for receiving the original video stream from the storage device such as the hard disk of the initiator's computer, a connected video camera, a Network Attached Storage (NAS), or the like, and transcoding it into a transferred stream. The transcoding takes into account the integrated data fed back to the initiator's platform from all viewers, as integrated by the analyzers such as QoS analyzer 316, network analyzer 320 and protocol analyzer 324. For example, if a particular viewer issued a STOP control command, the video streaming is stopped for all viewers. If a particular viewer reports low quality of service, for example if ten video seconds take twelve seconds to be received, then the frame rate is slowed for all viewers, including the initiator, in order to keep synchronization. In case there is more than one viewer in addition to the initiator, and the QoS of a particular viewer drops below a predetermined threshold, or below a predetermined percentage of the recommended QoS, then streamer 304 can stop transmitting the video to that particular viewer, in order not to harm the viewing experience of the rest of the viewers. The QoS indications and control commands are continuously collected from the viewers, received and integrated by streamer 304 so that the video stream is controlled by and synchronized for all viewers. Thus, the transmitted video stream takes into account the equipment, connection speed and quality and additional conditions available for all viewers, so at any given instance the video stream is suited for the current conditions. Transcoder 312 can use any proprietary or third party component such as On2 SDK, produced by On2 Technologies Inc. of Clifton Part, N.Y., U.S.A for producing the video stream.

In a configuration using a server, upon a session setup, streamer 304 starts a connection to the FMS. The connection is optionally implemented as a graph comprising a node for each viewer. The streamer then provides media file parsing and transcoding capabilities, that along with the abilities such as the On2 or other DirectShow filters create the required media streaming. Streamer 312 receives notification events from the FMS. The events are used to monitor the ongoing session and to receive application messages. The messages handling is implemented as part of the control protocol or the QoS protocol.

Referring now to FIG. 4, showing the messages and parameters transferred to and from the components of the disclosed apparatus, as detailed in association with FIG. 2 and FIG. 3 above. Streamer 400 receives input comprising encoder parameters, which are used to define the upload streaming characteristics, related to available and desired bandwidth, and to the required visual or audio quality. Input parameters 402 further comprise source media content characteristics, which are relate to the specific video to be shared, and environmental-related parameters. The encoder parameters can include but are not limited to any subset of the following parameters: a. Target bit rate, i.e., the predefined bitrate level that the transcoder should reach. b. Maximal quantization. Quantization is a compressing technique of gathering together similar elements in a given area and representing them as a single value. Thus higher quantization value implies lower image quality. c. Minimum distance to key frame. Key frame, also known as an I-frame, is a frame in the stream that is compressed independently of other frames. Other frames may relate to a key frame during the compression procedure. Distance between key frames is measured in number of frames. d. Frame dropping, which is one of the methods to lower the target bandwidth. e. The amount of processing power to be used for stream encoding. f. Drop frame water mark, i.e., at what load level start frame dropping. g. maximal allowed data rate, i.e. the percentage of target bit rate; and the target audio quality, in terms of bit rate, sampling rate or the like.

The source media content characteristics include but are not limited to any subset of the following parameters: compression type of the video; the video quality, in terms of frame size, frame rate, bit rate or the like; and the audio quality, in terms of bit rate, sampling rate or the like. The environmental-related parameters characteristics include but are not limited to any subset of the following parameters: streamer site capabilities or viewer site capabilities, such as CPU speed, available memory, video card, installed media processing components, network connection or the like; and geographical deployment considerations, including for example the best route between the initiator and the viewers, while considering the FMS, their locations and workload, or similar considerations.

Viewers 408 send three types of data sets to streamer 400. The first data set relates to QoS monitoring 410, which includes parameters related to the quality of service available to each viewer, such as but not limited to bit rate, frame rate, CPU overload, or the like. The second data set relates to client cue points monitoring 412, which include parameters indicating arrival of cue points that represent the time line of the video, and indications for distortions in the incoming stream. The third data set relates to control commands 416, which comprises control indications, such as a request of a particular viewer to stop the video, to seek a position, or the like. FMS 404 exchanges both with streamer 400 and with viewers 408 data 406 related to monitoring and adjustment of the FMS streamer itself.

Referring now to FIG. 5, showing a flowchart of the main steps of the method of the disclosed invention.

On step 500, the initiator browses into a predetermined web page providing the service. By using controls or other options enabled by the web page, on step 504 the initiator sends an invitation to a viewer with whom the initiator wishes to share a video clip. The invitation can be sent using any channel, including but not limited to an e-mail message, an instant message, a non-computerized invitation, or the like. The invitation preferably indicates or comprises an identifier such as a direct IP, a Session Initiation Protocol (SIP) command, a Uniform Resource Identifier (URI), a Universal Resource Locator (URL) or the like. In a preferred embodiment, the invitation can be encoded or represented, for example, by a non-comprehensible token that can be interpreted by the viewer's web application into a required set of parameters. In a preferred embodiment the invitation can include a time indication, such that when the time arrives, all viewers including the initiator are reminded to access the web page and their computing platforms automatically open a browser and browse to the web page.

On step 508 the one or more users browse to the required web page. If the web page was embedded in the invitation, the user can click or point at the link to enter the web page. Otherwise, the viewer can surf to the web page by typing the URL, using the favorite list or in any other method. On step 512 the initiator starts streaming a multimedia clip, such as a video clip, according to parameters related to the environment, to the video, the quality requirements or the like. The streaming includes embedding cue points within the stream. On optional step 516 the initiator uploads the streamed video or multimedia to a streaming server. The streaming server is preferably not a storage server, thus enhancing the privacy of the relevant parties. On step 520, the streamed multimedia is sent to the platforms of all viewers, including the initiator's. If on step 516 the stream was sent to a streaming server, the streaming server sends the stream to all viewers; platforms. Otherwise on step 520 the initiator's platform sends the stream to the viewers' platforms, including itself. On step 522 the stream is displayed or otherwise presented to the viewers on the web page on the viewers' platforms, including the initiator's.

On optional step 524 any viewer, including the initiator or the other viewers can issue a control command related to viewing the multimedia. If the multimedia stream is a video stream, the control command can be a “stop”, “continue”, “pause”, “fast forward”, “fast backward”, “seek to position” or any other command. The control command is sent to the On step 528 the platform of any viewer sends to the initiator's platform one or more Quality of Service (QoS) related parameter, indicating for example network parameters related to the available and requested bandwidth, the bit rate of the stream, the frame rate, or the like. On step 532 the platform of any viewer sends to the initiator's platform monitoring indications relating to one or more cue points, for example how much time elapses between two consecutive 10-seconds indications, or the like. The indications enable the initiator's platform to monitor the viewer's reception of the video and adjust the streaming accordingly. All considerations, including the control command issued on step 524, the QoS parameters issued on step 528 or the cue points monitoring indications issued on step 532 are sent to the initiator and on step 536 the initiator's platform updates the multimedia streaming according to the commands, parameters and indications sent from the viewers, and optionally parameters sent from the streaming server. The multimedia stream is stopped, seeks to a position or otherwise changes according to the commands. The rate, quality, dropped frames and other parameters of the streaming are also updated according to the received data. The process continues until all viewers, including the initiator's exit the web page.

A person skilled in the art will appreciate that the streamed multimedia or any other type of information passed in the system, such as the control commands, the invitations or others can be compresses or encrypted using any known or proprietary compression or encryption method by the streamer and decompressed or decrypted using a corresponding decompression or decryption method by any viewer, including the initiator and optionally the streamer. Thus, even if an uninvited viewer intercepts the video, he or she can not parse or present it.

The disclosed method and apparatus provide video sharing between an initiator and optionally one or more viewers wherein the transmitted stream takes into account the control and limitations of all viewers including the initiator and optionally the streamer. Thus, the stream takes into account the current limitations imposed by the platforms and connections used by all viewers including the initiator and optionally the streamer, and adjusts the vide stream accordingly. Thus, all viewers view exactly the same video at the same time, in a simultaneous and synchronous manner. Further, the stream is controllable by all viewers, so the viewers enjoy the benefits of watching the video together. Unlike current systems, in which only the initiator has control over the video, in the disclosed method and apparatus all viewers can have control. Yet another advantage of the disclosed method and apparatus is that the video is not uploaded to a third party server and s not stored anywhere, thus protecting the privacy and security of the involved parties. Since downloading the video to the viewers is done in parallel to the upload of the video to a streaming server, no delay is caused by having to first upload the video as a whole and only then download it. The video can be shared at the same time it is first played by the initiator or when it is downloaded from the capturing device.

It will be appreciated by a person skilled in the art that the disclosed method and apparatus is not limited to video and can be used for any type of information, including audio, images, text, data, or multimedia stream of any type and of any format, or any other information type. In a preferred embodiment, each viewer apparatus comprises an instant messaging or chat component, which automatically connects all viewers to one chat session or conversation, so that the viewers can discuss the video, make decisions or the like.

The disclosed invention also covers a computer storage device comprising computer instructions that perform the disclosed methods. The computer instructions are performed via components of the apparatus as described.

It will be appreciated by persons skilled in the art that the present disclosure is not limited to what has been particularly shown and described hereinabove. Rather the scope of the present disclosure is defined only by the claims which follow.

1. In a computerized network, a method for sharing a multimedia clip between an initiator and an at least one viewer, the initiator using an initiator computing platform and the at least one viewer using a viewer computing platform, the computing platforms connected to the network via connections, the method comprising:
streaming the multimedia clip into streamed multimedia, the streaming performed in accordance with an at least one consideration;
downloading the streamed multimedia to the computing platforms of the initiator and the at least one viewer;
presenting the streamed multimedia to the initiator and to the at least one viewer;
sending the at least one consideration from the initiator or from the at least one viewer to the initiator; and
updating the streaming of the multimedia clip according to the at least one consideration.

2. The method of claim 1 wherein the multimedia clip is a video clip or an audio clip or an at least one image.

3. The method of claim 1 wherein the at least one consideration relates to the initiator computing platform or the at least one viewer computing platform.

4. The method of claim 1 wherein the at least one consideration relates to the connections used by the initiator computing platform or the at least one viewer computing platform.

5. The method of claim 1 wherein the at least one consideration relates to a control command issued by the initiator or the at least one viewer.

6. The method of claim 1 wherein the at least one consideration relates to a cue point monitoring indication sent by the initiator computing platform or the at least one viewer computing platform.

7. The method of claim 1 wherein the at least one consideration relates to a quality of service parameter issued by the initiator computing platform or the at least one viewer computing platform.

8. The method of claim 7 wherein the quality of service parameter relates to a network resource or platform capabilities of the initiator computing platform or the at least one viewer computing platform.

9. The method of claim 1 wherein the streamed multimedia is presented synchronously to the initiator and to the at least one viewer.

10. The method of claim 1 wherein the streamed multimedia is presented instantly to the initiator and to the at least one viewer.

11. The method of claim 1 further comprising a step of uploading the streamed multimedia to an at least one streaming server.

12. The method of claim 1 further comprising a step of sending an invitation from the initiator to the at least one viewer.

13. The method of claim 12 wherein the invitation is sent as an e-mail or as an instant message.

14. The method of claim 12 further comprising the steps of encrypting and decrypting the invitation.

15. The method of claim 12 wherein the invitation comprises at least one item selected from the group consisting of: a Universal Resource Locator (URL); a Universal Resource Identifier (URI); a Session Initiation Protocol (SIP) command; and an Internet Protocol (IP) address.

16. The method of claim 1 further comprising the steps of compressing and decompressing the multimedia stream or the at least one consideration.

17. The method of claim 1 further comprising the steps of encrypting and decrypting the multimedia stream or the at least one consideration.

18. A computerized apparatus for sharing a multimedia clip between an initiator and an at least one viewer, the initiator using an initiator computing platform and the at least one viewer using a viewer computing platform, the computing platforms connected to the network via connections,
the viewer computing platform executing a viewer component, and the initiator computing platform executing:
a streamer component for streaming the multimedia clip and generating a multimedia stream according to an at least one consideration received from the viewer computing platform or from the initiator computing platform;
a viewer component for displaying the multimedia and transmitting an at least one consideration to the streamer component; and
an at least one analyzer component for analyzing indications received from the at least one viewer computing platform or from the viewer component.

19. The computerized apparatus of claim 18 wherein the multimedia clip is a video clip or an audio clip or an at least one image.

20. The computerized apparatus of claim 18 wherein the viewer component comprises:
a player component for displaying the multimedia stream and transmitting the at least one considerations to the streamer component executed by the initiator computing platform; and
an at least one indicator component for issuing to the initiator computing platform an at least one indication related to the viewer computing platform or the viewer or the initiator computing platform or the initiator.

21. The computerized apparatus of claim 18 wherein the at least one analyzer component comprises one or more items selected from the group consisting of:
a quality of service analyzer for integrating quality of service indications from the at least one viewer computing platform or from the initiator computing platform;
a network analyzer for integrating network resources indications received from the at least one viewer computing platform or from the initiator computing platform; and
a control analyzer for integrating control commands received from the at least one viewer or the initiator.

22. The computerized apparatus of claim 20 wherein the indicator component comprises one or more items selected from the group consisting of:
a network analyzer for obtaining and transmitting to the initiator computing platform an at lest one indication related to network characteristics of the viewer computing platform and connection or to the initiator computing platform and connection;
a quality of service protocol implementation component for obtaining and transmitting to the initiator computing platform an at least one quality parameter related to the multimedia stream; and
a control protocol implementation component for receiving an at least one control command from the at least one viewer or from the initiator and transferring the at least one control command to the initiator computing platform.

23. The computerized apparatus of claim 18 further comprising an at least one streaming server for receiving the multimedia stream from the initiator computing platform and sending the multimedia stream to the at least one viewer computing platform and to the initiator computing platform.

24. The computerized apparatus of claim 18 wherein the streamer component comprises one or more items selected from the group consisting of: a quality of service protocol implementation component, a network implementation component; and a control protocol implementation component.

25. A computer readable storage medium containing a set of instructions for a general purpose computer, the set of instructions comprising:
a streaming component for streaming a multimedia clip into streamed multimedia, the multimedia clip to be shared between an initiator using an initiator computing platform and an at least one viewer using an at least one viewer computing platform, the streaming performed in accordance with an at least one consideration;
a downloading component for downloading the streamed multimedia to the initiator computing platform and the at least one viewer computing platform;
a presentation component for presenting the streamed multimedia to the at least one viewer and to the initiator; and
a component for sending the at least one consideration from the initiator or the at least one viewer to the initiator.
